(19) United States
(12) Patent Application Publication
(10) Pub. No.: US 2011/0256296 A1
(43) Pub. Date: Oct. 20, 2011

(54) AERATED CHEESE AND METHOD

(76) Inventors: James S. Thorson, Scandia, MN (US); Erika B. Smith, Champlin, MN (US)

(21) Appl. No.: 13/087,655

(22) Filed: Apr. 15, 2011

Related U.S. Application Data
(60) Provisional application No. 61/324,808, filed on Apr. 16, 2010.

(51) Int. Cl. A23C 19/00

(52) U.S. Cl. 426/582; 426/474

(57) ABSTRACT

Aerated cheeses and methods of making aerated cheeses. Aerated cheese is formed of a solidified aerated molten cheese mixture. The cheese is prepared by aerating a molten cheese mixture with a gas in a high shear, aeration device to form an aerated molten cheese mixture and then cooling the mixture to form the aerated cheese.

### CROSS-REFERENCE TO RELATED APPLICATIONS

This application claims the benefit of priority under 35 U.S.C. 119(e)(1) of a provisional patent application Ser. No. 61/324,808, filed Apr. 16, 2010, which is incorporated herein by reference in its entirety.

### FIELD OF THE INVENTION

The invention relates generally to cheese and methods of making cheese, and more specifically to aerated cheese and methods of making aerated cheese.

### BACKGROUND OF THE INVENTION

Cheese can be made by various processes such as cultured or non-cultured processes. Some cheese can be made from cheese compositions. Generally, cheese compositions can be prepared from cultured, non-cultured, natural, non-natural, imitation or substitute cheeses or cheese formulations. Examples of cheese compositions and processing methods can be found in the U.S. patent application publication numbers 2006/0159825 and 2005/0106303.

### SUMMARY OF THE INVENTION

For various reasons, it is desirable to provide an aerated cheese and method for making aerated cheeses from cheese compositions or mixtures. Aerated cheese may have lower densities than non-aerated cheese and may provide a product having a comparatively greater volume for equal weight of non-aerated cheese. The invention in its various embodiments provide aerated cheeses and processes for making aerated cheeses.

In an embodiment of the invention, a process for making an aerated cheese includes the steps of aerating a molten cheese mixture with a gas in a high shear, aeration device to form an aerated molten cheese mixture and cooling the aerated molten cheese mixture to solidify the mixture and form the aerated cheese. The process may further include other processing and handling steps, e.g., shredding, cutting or packaging the aerated cheese.

In various embodiments of a process according to the invention, the aeration step may result in a solidified aerated cheese having a % gas content by total volume of 50% or less by about 40%, about 5% to about 40%, about 1% to about 30%, about 5% to about 30%, about 1% to about 20%, about 5% to about 20%, about 1% to about 10%, or about 5% to about 10% by total volume of cheese. In a particular embodiment of a process according to the invention, the aeration step is carried out with a pin-type aerator at a gas flow rate sufficient to provide the aerated cheese with a gas content of about 5% to 50% gas by total volume.

In another embodiment of the invention, an aerated cheese comprising a solidified aerated molten cheese mixture is provided. In some embodiments, the aerated cheese of the invention may have a bulk density from about 0.7 grams/cc to about 1.10 grams/cc. In yet other embodiments, the aerated cheese does not flow at room temperature when placed on a surface with no external forces applied. Some aerated cheeses prepared according to processes of the invention softens at baking temperatures.

Aerated cheeses according to the invention may be packaged in bulk, incorporated into other food products, cut, diced, shredded or otherwise sized or processed for particular uses. For example, in an embodiment of the invention, the aerated cheese may be shredded and then used as a topping for pizza. The cheese shreds in some embodiments will have a length and a plurality of cross-sectional dimensions and a plurality of gas bubbles that are of a size not larger than ½ of the narrowest cross-sectional dimension.

In some embodiments, an aerated cheese of the invention has a gas content by total volume of 50% or less by volume of cheese. In yet other embodiments, the aerated cheese may have a % gas content ranging from about 1% to about 50%, such as about 1% to about 40%, about 5% to about 40%, about 1% to about 30%, about 5% to about 30%, about 1% to about 20%, about 5% to about 20%, about 1% to about 10%, or about 5% to about 10% by total volume of cheese.

In a particular embodiment of the invention, an aerated cheese is provided, comprising a solidified aerated molten cheese mixture; and the aerated cheese has a gas content of about 1% to about 20% by total volume of the cheese, a bulk density of about 0.7 grams/cc to about 1.10 grams/cc and average void size in the range of about 0.1 microns to about 1500 microns.

### BRIEF DESCRIPTION OF THE DRAWINGS

FIG. 1 is a block flow diagram of an embodiment of a process of the invention.

FIG. 2 is a flow diagram of an embodiment of a process of the invention.

FIG. 3 is side-by-side photographic images of samples of an aerated cheese according to an embodiment of the invention and of a non-aerated cheese.

### DETAILED DESCRIPTION

In general, cheese may be classified as either natural cheese or non-natural cheese. However, the classification of cheese may vary within the cheese industry. For example, cheese may also be classified as cultured, non-cultured, imitation or substitute cheese. Regardless of the particularity classification system, aerated cheese of the invention may be made of natural, non-natural, cultured, non-cultured, analog, imitation or substitute cheese compositions and combinations thereof.

As used herein, the terms “cheese composition” or “cheese mixture” may be used interchangeably and refer to a composition used to make cheese products, and more specifically aerated cheese. For example, “cheese composition” could refer to a composition during one or more stages of cheese manufacturing, such as when cheese composition ingredients are being mixed together. As another example, “cheese composition” could refer to a mixture of cheese ingredients that have been mixed and/or heated and/or aerated as well as to molten natural cheese and combinations thereof. “Cheese product” refers to a composition that is in the form of a final cheese product, ready to be sold for human consumption such as a snack. For example, a cheese product could be in the form of a cheese block, sliced cheese, shredded cheese, diced cheese, crumbled cheese, or combinations of these, and the like.

Natural or cultured cheese composition can be characterized as being made directly from milk. Moreover, the United States Department of Agriculture (USDA) has specific standards for natural cheese products including ingredients used, manufacturing procedures used, and final nutritional value. Natural cheese is well known and is commercially available.

Non-natural or non-cultured cheese can include substitute cheese, process cheese substitutes, and imitation cheese.

In general, “substitute cheese” means a product that is a substitute for, and resembles another cheese, yet is not nutritionally inferior. 21 C.F.R. §§101.3 and 102.5, the respective entireties of which references are incorporated herein by reference, defines substitute and imitation food products. A substitute mozzarella cheese is further defined by 21 C.F.R. §§133.3, 133.5, and 133.155, the respective entireties of which references are incorporated herein by reference.

As used herein, an “imitation cheese” means a cheese that resembles another cheese but is nutritionally inferior.

With this in mind, the invention provides aerated cheeses and methods of preparing aerated cheeses.

Aerated cheeses of the invention may be formed from a variety of cheese compositions, including “natural cheese” compositions, “substitute cheese” compositions and “imitation cheese” compositions. Any cheese or cheese composition that can be processed in molten form through or in an aeration device is suitable for use in preparation of aerated cheese according to the invention. Examples of suitable cheeses include, but are not limited to, processed “American” cheeses, mozzarella, cheddar cheese, Romano cheese, and fondue cheeses such as Emmenhol, Gruyere, and Comte to name a few.

For one or more reasons such as economic (cost efficiency), health or other reasons, it is desirable to provide cheeses formed of cheese compositions having comparatively reduced densities. It has been found that it is possible to provide cheese having comparatively reduced densities by introduction of one or more gases into molten cheese compositions or mixtures prior to the cheese composition setting or solidifying. The gases can be introduced via aeration. Aerated cheeses would have a reduced density per volume compared to non-aerated cheeses formed from the same cheese compositions or mixtures.

In general, aerated cheeses of the invention include, but are not limited to, mozzarella cheese, cheddar cheese, American cheese, imitation cheese and the like. Preferred aerated cheeses include mozzarella cheese and mozzarella substitute cheese. Aerated cheese of the invention can be combined with other ingredients to produce other food products that include cheese (e.g., snack food) including pizza, pizza-type snack food, and the like. Preferred food products include aerated mozzarella cheese and/or aerated mozzarella substitute cheese of the invention.

Suitable cheese compositions may be one of a variety of cheese compositions as previously noted. Examples of cheese compositions that may be utilized include, but are not limited to, compositions such as those disclosed in co-owned U.S. patent application publication numbers 2006/0159825 and 2005/0106303. Cheese compositions typically can include protein, fat, non-pregelatinized, modified starch, emulsifying salt, and water, and may further include various other additives.

Fat in cheese compositions can influence texture and melting characteristics of the cheese composition. Fat is commonly known as fat, shortening, or oil. Fat can be either liquid or solid at room temperature, or a combination of liquid and solid at room temperature. Useful fat ingredients can include vegetable fat, dairy fat, or combinations thereof. Exemplary fat ingredient includes hydrogenated coconut, cottonseed, soybean, groundnut, palm kernel, corn, canola, safflower and combinations thereof. These fat ingredients are well known in the cheese industry and are commercially available. A useful amount of fat in a cheese composition includes an amount that provides suitable properties such as cheese composition texture and melting properties. Such an amount can be in a range from about 15% to about 35% by weight of the total cheese composition.

Protein can significantly influence one or more of functional, organoleptic, or nutritional properties of a cheese composition because it generally forms a three-dimensional network within a cheese composition. For example, protein can influence melt, stretch, machinability, depositing performance, freeze/thaw stability, pizza bake performance, taste, and color characteristics of a cheese composition. Protein can also influence nutritional characteristics. Proteins that can be used in cheese compositions include dairy proteins like casein protein. Other, non-casein and/or non-dairy proteins such as vital wheat gluten protein can also be used in cheese compositions.

Casein protein is an edible protein that can be found naturally in milk and that is conventionally known to provide many important characteristics in cheese compositions. In fact, it is conventionally thought that a certain amount of casein protein is required to provide certain functional and/or organoleptic properties. As used herein, the term “casein protein” means casein in all its forms, including rennet casein, acid casein, caseinate derivatives, fresh cheese, and dehydrated cheese. Casein proteins are well known in the cheese industry and are commercially available. For example, rennet casein can be commercially purchased from Kerry Ingredients (Beloit, Wis.).

A useful amount of protein in a cheese composition of the invention includes an amount that can provide a cheese composition with suitable functional properties, organoleptic properties, nutritional properties, and combinations thereof. Such properties may include melt, stretch, machinability, depositing performance, freeze/thaw stability, pizza bake performance, taste, and color of a cheese composition. Protein may also influence nutritional characteristics. As an example, useful amounts of casein protein in some embodiments of a cheese composition of the invention may include amounts in a range from 10-20% by weight of the total cheese composition.

As earlier mentioned, non-casein proteins, including dairy protein, non-dairy protein, or combinations thereof, may be used in cheese compositions. It is known that non-casein protein and non-pregelatinized, modified starch, in combination, can make-up for shortcomings in functional, organoleptic, and/or nutritional properties in cheese compositions prepared with a reduced amount of casein protein. Such highly desirable properties can be similar to those obtainable by using an unreduced amount of casein protein. That is, non-casein protein, in combination with non-pregelatinized, modified starch, can replace an amount of casein protein (i.e., act as substitute for casein protein). Non-casein proteins include, dairy proteins naturally found in milk (e.g., whey protein concentrate or isolate), gluten protein (e.g., vital wheat gluten protein), soy protein, wheat protein, and wheat protein isolate to name a few. As an example, a vital wheat gluten protein is commercially available from ADM Food Ingredients (Olathe, Kans.), under the trade designation PROVIM ESP. In some but not all cheese compositions of the invention, exemplary useful amounts of non-casein protein can include amounts in a range from 1-4% of the invention by weight of the total cheese composition. Non-limiting examples of starches that can be used include potato starch, such as Novation 1600, commercially available from National Starch and Chemical Company, and corn starch.

In addition to fat, water, protein and starch, the cheese compositions additionally may include emulsifying salts, also called chelating salts. Exemplary emulsifying salts include, but are not limited to, monosodium phosphate, disodium phosphate, dipotassium phosphate, trisodium phosphate, sodium metaphosphate (sodium hexametaphosphate), sodium acid pyrophosphate, tetrasodium pyrophosphate, sodium aluminum phosphate, sodium citrate, potassium citrate, calcium citrate, sodium tartrate, sodium potassium tartrate, and combinations thereof.

The cheese compositions may include various additives as known to those skilled in the art. One or more optional ingredients known in the art may be used with cheese compositions of the present invention. Such optional ingredients include acidifying agents, cream, milkfat, milk, salt, artificial coloring, spices or flavorings, mold-inhibitor, nutritional supplements, vitamins, gums, organic emulsifiers, minerals, and other types of cheese than the given cheese composition. Exemplary acidifying agents include, but are not limited to, one or more of vinegar, lactic acid, citric acid, acetic acid, and phosphoric acid. Mold inhibitors can include, for example, one or more of the following: sorbic acid, potassium sorbate, sodium sorbate, sodium propionate, calcium propionate, and nisin.

In a method of the invention, a cheese composition is provided in a heated or molten form. As necessary, a composition may be further heated to increase flowability of the cheese composition or to maintain the composition in molten form.

To aerate a cheese composition, a gas is introduced into the cheese composition through an aeration process. A variety of gases may be utilized. Also, gases utilized in cheeses and methods of the invention, preferably, do not react with the components of the cheese compositions during processing or with the aerated cheese after solidification. For some but not all embodiments, the gas is water insoluble. Fat soluble gases may also be used. Suitable gases include, but are not limited to, air or specialty gases such as helium, nitrogen, carbon dioxide, noble gasses (e.g., neon, argon, krypton, xenon). These may be used alone or in combination with other suitable gases.

In order to aerate the cheese composition, it is processed in or passed through a gas-liquid mixing device that is generally referred to as an aeration device. Any of a variety of commercially available mixers or mixing devices may be utilized as an aeration device. Aeration devices that can be operated at high shear rates are particularly useful and include, but are not limited to, traditional mixing or blending equipment such as vats or tanks equipped with motor driven stirrers having various configurations, e.g., paddle, helix, etc., batch high shear mixers, inline high shear mixers, ultra high shear inline mixers, pin-type aeration device, ultrasonic mixers (e.g., Sonolator from Sonic Corp, Conn.), pipeline static mixers, hydraulic shear devices, rotational shear mixers, rotor stator mixers, inline shear mixers, jet mixers, venturi-style/cavitation shear mixers, microfluidizer shear mixers and high-pressure homogenization shear mixers (Microfluidics Inc.). Any other suitable high-shear generating mixer capable of producing the desired gas bubble size or distribution or cheese density may be utilized.

Regardless of the physical processes or specific type of mixer, a cheese composition or cheese of the invention should have gas bubbles or void spaces dispersed throughout the composition prior to and upon solidification. It is through the introduction and dispersion of gas bubbles throughout the cheese composition that a solidified cheese having the desired density or bubble size distribution can be obtained.

In some embodiments, the final density of the solid cheese can be from about 0.7 to about 1.10 gram/cc after solidification. Such densities can be obtained by aerating molten cheese compositions to provide an aerated molten cheese composition having a bulk density of about 0.55 to about 1.07 gram/cc.

The aerated cheese may have a mean gas bubble or void size in the range of about 0.1 microns to about 1500 microns, or about 1 micron to about 1000 microns, or about 1 micron to about 500 microns, or about 1 micron to about 300 microns or about 10 microns to about 150 microns. It should be understood that these ranges are not intended to be limiting and that any range from about 0.1 microns to about 1500 microns is within the scope of the invention. Thus aeration is to be conducted under conditions sufficient to provide such a mean gas bubble or void size or a desired overall density.

Some aerated cheeses of the invention will soften at oven baking temperatures. The composition of the cheese mixture or the size or distribution of gas bubbles in the aerated cheese can affect whether the aerated cheese will soften, dry out or burn during exposure to oven baking temperatures. In some aerated cheeses where a baked cheese that softens is desired, the amount of gas present may be about 25% or less of the total volume of the cheese. In others, the amount of gas may be about 20% or less of the total volume. In yet others, the amount of gas may be about 10% or less or about 5% or less of the total volume. For some other embodiments of aerated cheese according to the invention, gas may be present in amounts of about 50% or less by volume of cheese, or in amounts ranging from about 1% to about 50%, such as about 1% to about 40%, about 5% to about 40%, about 1% to about 30%, about 5% to about 30%, about 1% to about 20%, about 5% to about 20%, about 1% to about 10%, or about 5% to about 10% by total volume of cheese.

Thus, some solidified, aerated cheese of the invention may have gas bubbles or void spaces averaging from about 0.1 microns to about 1500 microns in size and/or an average void ratio ranging from about 1:1 to about 1:99 and/or an average bulk density ranging from about 0.700 cc/gram to about 1.1 cc/gram after solidification.

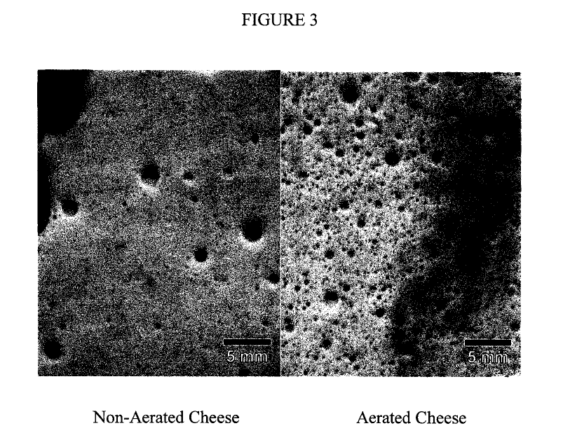

For illustrative purposes, FIG. 3 provides a visual comparison of the bubble or void space distribution in a non-aerated cheese and an aerated cheese. Referring to FIG. 3, two side-by-side images are provided. One image is of a surface of a piece of a non-aerated cheese and the other image is of a surface of a piece of aerated cheese of the invention. The two cheese samples were prepared from the same cheese composition or mixture. The effect of aeration can readily be seen in the aerated cheese with its significantly larger number of gas bubbles or void spaces and of the number of finer or narrower diameter bubbles or void spaces.

Aerated cheese of the invention can be shredded after solidification and packaged or provided in the form of shreds, pieces whose sizes are suitable for shredded cheese. In general, cheese fragments used in such embodiments of the invention may be regular or irregular sized shreds, dices, particles, or slices; regular sized shreds or particles are preferred. The size of the shredded pieces can vary widely but are generally about 1/32 to about ⅜ inches in diameter and about 0.75 to about 3 inches in length. They can also be about 1/16 to about ⅛ inches in diameter and about 1 to about 2 inches in length. Of course, other shaped particles having similar dimensions to those just discussed can be used in the practice of this invention; such other shaped particles are intended to be included within the terms “shreds,” “shredded,” and the like.

It should be understood that shreds do not necessarily have a cross-section that is spherical and the term “diameter” is used broadly to refer to a cross-sectional dimension of shreds regardless of the shape of the cross-section. For example, the shred may have a cross-section that may loosely be viewed as polygonal. In a shred with such a cross-section, there is more than one diameter, i.e., lengths or distances across the polygonal cross-section. It further should be understood that the side of the cross-sections may not all be straight lines. For example, the sides or edges of the cross-section may be jagged, irregular, curvilinear, etc. Consequently, shreds may also be generally characterized as having a length and a plurality of cross-sectional dimensions. In order to provide shredded cheese according to the invention with a more uniform appearance or to provide shreds that do not readily break or further fragment, the size of the gas bubbles or voids should be less than the smallest or narrowest cross-sectional dimension, e.g., diameter, of the shreds. For some shreds, the gas bubble or void generally may be no greater than half (½) the distance of the smallest or narrowest cross-sectional dimension of the shred. For some other shreds, the bubble or void generally may be no greater than one-third (⅓) the smallest or narrowest cross-sectional dimension of the shred.

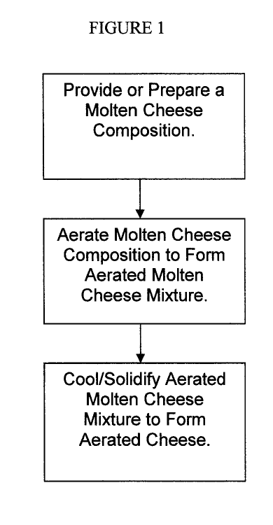

Aerated cheeses according to the invention are made from aerated molten cheese compositions. As shown in FIG. 1, an embodiment of the method of the invention comprises providing or preparing a molten cheese composition, aerating the molten cheese composition to form an aerated molten cheese mixture and cooling the aerated molten cheese mixture to form an aerated cheese. In various embodiments of the method of the invention, a molten cheese composition as previously described is aerated using an aeration device as described above. Once the molten cheese composition is processed through the aeration device with the introduction and distribution of gas bubbles throughout the composition, an aerated molten cheese mixture is formed. The cheese mixture is then solidified to form the aerated cheese. In some embodiments of an aerated cheese of the invention, the cheese may be characterized as solid or solidified if it does not flow at room temperature when placed on a surface with no external forces applied. Solidification may be achieved by passively or actively cooling the aerated molten cheese mixture. Once solidified, the aerated cheese may be further processed or cut into blocks, slices, shreds and the like.

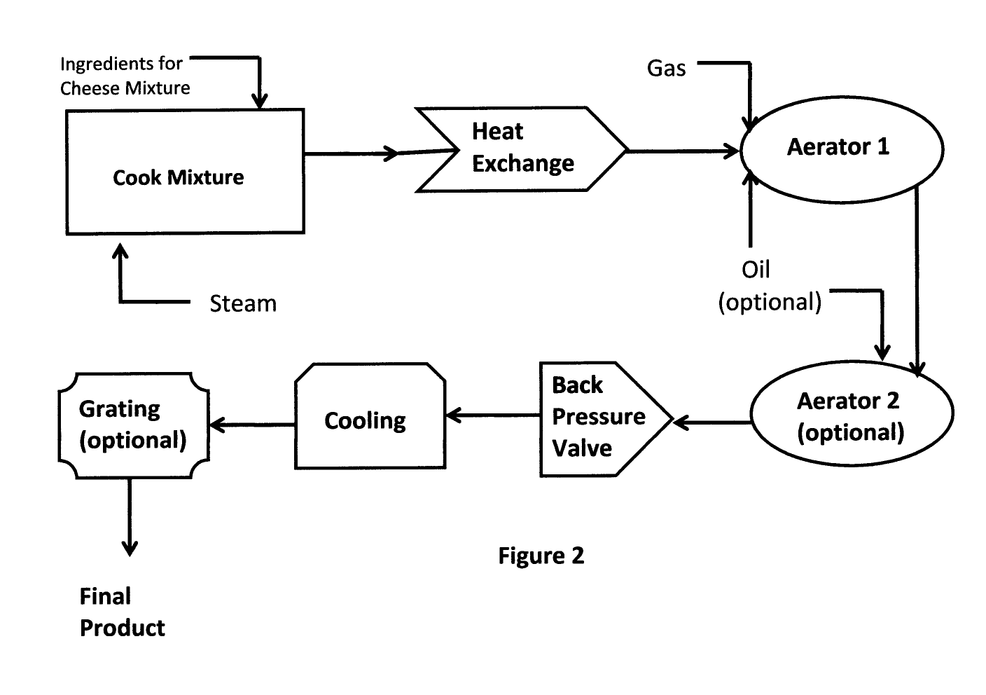

With reference to the flow diagram of FIG. 2, an embodiment of the method of the invention may be generally understood. The ingredients that make up the cheese mixture or cheese composition are added to a cheese cooker, mixed and steam is directed through the cheese cooker. When the cooking step is complete the resultant molten cheese mixture may be routed or conveyed to an aeration device, Aerator 1, where the mixture is aerated to provide an aerated molten cheese mixture. After aeration is complete, the aerated molten cheese mixture is then cooled and may be transferred from the aeration device to a container in which the aerated molten cheese mixture will be cooled or otherwise allowed to cool in order to solidify the mixture and form an aerated cheese according to the invention. As can be seen in FIG. 2, an optional second aeration device, Aerator 2, may be provided and the molten cheese mixture may be subjected to a further aeration step. Thus, it should be understood that a plurality of aeration devices may be utilized. Optionally, as aeration is carried out, oil may be added into the mixture to maintain flowability of the mixture. If oil is to added into the aeration device, this oil would be a portion of the total amount of oil content according to a given cheese formulation. Thus, less than the total amount of oil required for the cheese formulation would initially be added into the cooker and the remainder, an oil portion, would be added during aeration. This later addition of a portion of the oil may influence emulsification, texture and possibly melt properties of some aerated cheeses of the invention. Also, since the extent of aeration or % gas content by volume of the aerated molten cheese mixture is affected by pressure, a back pressure valve may be utilized to regulate or maintain pressure across the aeration device at a desired set point. As mentioned, the aerated cheese of the invention may be the final product, incorporated into other food products, or otherwise further processed. In FIG. 2, an optional grating or shredding step is shown.

A cheese composition to be used in forming the aerated cheese of the invention may generally be prepared utilizing cheese cookers, which are commercially available and well known. An example of such a cooker includes a variable speed, twin screw, steam injected cheese cooker from Custom Stainless Steel Equipment (Santa Rosa, Calif.) such as Model No. CDB-0412FJD.

In general, the cheese cooker system is allowed to warm up. Next, ingredients are added to the cooker and the ingredients are heated. Ingredients can be added in one group, or at different times. The ingredients are then mixed, while the temperature is maintained at an elevated state to form a molten cheese mixture or molten cheese composition. The molten cheese mixture is then processed through one or more aeration devices to form an aerated molten cheese mixture. The aerated molten cheese mixture is then solidified and/or cooled to form an aerated cheese.

For illustrative purposes, a more specific description of an example of how a cheese composition can be made using a cheese cooker and a high shear aeration device is given below.

First, the cheese cooker is readied by setting the steam to a pressure of about 40 psi. Condensate valves are opened to allow the steam to flow through the pipes. Once the condensate is cleared, the steam is directed through the cheese cooker by closing the steam outlet valve. The steam is sent through the injection ports to ensure that the ports are open and unplugged.

The cover to the mixer portion of the cheese cooker is then closed and the cheese cooker is allowed to warm up. After the mixer has been sufficiently heated, the steam valves on the cheese cooker are closed. Some of the ingredients, if necessary, can be mixed separately, or melted. For example, if semi-solid shortening or a previously formed, meltable cheese is used, it may need to be melted before being added to the cooker. Typically, water is added to the cooker and allowed to warm to a desired temperature before adding other ingredients.

The steam drain valves on the cheese cooker are opened again to clear condensate, the agitator is started and the water is added to the cooker. The steam valves are then opened and steam is allowed to enter the cooker through the injection ports. The cover is closed and the temperature is allowed to rise to a temperature in the range from about 175° F. to about 200° F. (about 79° C. to about 93° C.) while mixing is maintained.

Once the water is heated, emulsifier salt or other soluble ingredients are added and allowed to dissolve before the separately mixed portion(s) are added to the cheese cooker. The agitation speed is controlled to ensure proper mixing. If the temperature of the ingredients decreases, the ingredients are heated to a temperature in the range from 175° F. to 185° F. (about 79° C. to about 85° C.) by closing the mixer cover and adding more steam to the cooker. Preventing addition of an excessive amount of steam is preferred, since addition of too much water to the overall mixture is not desired.

The steam is then shut off and the cover opened to allow visual confirmation of the molten cheese composition. The mixer should remain running in order to obtain a homogenous mixture. The temperature should be maintained at about 170° F. (about 76° C.). At this point, the cheese mixture may begin to thicken and to take on a creamy texture. The transformation may occur about 2 to about 8 minutes after the last ingredient has been added to the cooker. When the formation of the cheese composition is complete, the molten cheese composition is drained into an appropriate container and/or conveyed to an aeration device for high shear mixing to introduce gas into the molten cheese. For some applications, the cheese cooker may be equipped to aerate the molten cheese mixture without need for transfer to another container or a separate aeration device.

After the aeration step, the aerated molten cheese mixture is allowed to solidify and form an aerated cheese of the invention. This can be accomplished by passively or actively cooling the mixture. For some, but not all, aerated cheeses of the invention, the cheese mixture may be cooled to a temperature in the range from about 32° F. to about 40° F. (about 0° C. to about 5° C.) to form the aerated cheese. Regardless of target temperature, cooling of the aerated molten cheese mixture can simply be accomplished by letting it stand in a container in a cool environment and/or by cooling the container or vessel holding the aerated molten cheese mixture.

Aerated cheeses according to the invention can be eaten as is, a final cheese product, or further processed and formed into or included in edible food products. Final cheese products of the invention can be packaged alone or combined with other food products before packaging. Final cheese products that may be packaged alone include string cheese, shredded cheese (e.g., shredded mozzarella cheese and shredded cheddar cheese), sliced cheese, cheese crumbles, cheese dices and block cheese. Aerated cheese of the invention may also be combined with or incorporated into other food products or ingredients before being packaged, frozen or refrigerated, and stored for later use and/or consumption. Such cheese products can be incorporated or combined with other food products in any suitable way. For example, final cheese products of the invention can be applied in any suitable form, (e.g., shredded) onto other food products such as pizza by any suitable, conventional means. As further examples, aerated cheese of the invention can be introduced in any suitable form into other food products that include cheese, such as a filling for a “pizza roll” (e.g., Totino's® Pizza Rolls), a calzone, a pot pie, a “turnover,” or other pastry-type or baked or microwavable food product that may additionally contain meat, vegetables, or sauces.

In certain preferred embodiments, aerated cheeses according to the invention and/or food products including them may be described, as having, for example, comparatively lower or reduced caloric content or % content of various nutrients when compared by volume to non-aerated cheeses.

### Test Protocols

A. Determination of Stretch Test Value for a Cheese Composition

As used herein, the term “Stretch Test Value” means the value assigned to a cheese composition after applying the following test protocol on the cheese. An oven is preheated to 450° F. A wedge of cheese is sliced to a thickness of about 0.5 inches. A disc-shaped piece of cheese is cut from the wedge using a metal circular cutter (39.2 mm diameter, 7.3 mm deep). The weight of the disc of cheese should be from about 8.5 to about 8.9 grams (trim disc with circular cutter if needed). The disc of cheese is then placed in the center of a 15 mm′ 100 mm glass Petri dish. Then the cover of the Petri dish is placed over the Petri dish and the dish is placed in the oven for exactly 5 minutes. The Petri dish is then removed from the oven and allowed to cool for about 30 seconds. The cover is removed and a fork is wedged into the cheese disc and pulled upwards so as to stretch the cheese. The length that the cheese can be stretched until breaking is measured and recorded. A good sample will have a Stretch Test Value of 15 inches or more for a cheese where stretch is an important characteristic of the cheese; however, a substantially lower Stretch Test Value is acceptable for other cheeses. For example, a cheese may have a Stretch Test Values of less than 10, or less than 5 or even less than 3 and be suitable. The appearance of the cheese disc is also observed and recorded. A satisfactory cheese should not be burnt and a minimum to no amount of free oil or water should be visible.

B. Determination of Melt Test Value for a Cheese Composition

As used herein, the term “Melt Test Value” means the value assigned to a cheese composition after applying the following variation of the Schreiber test protocol on the cheese. The procedure for determining a Melt Test Value is as similarly described above with respect to determining a Stretch Test Value with the added steps of measuring the “spread” of the cheese after it has been baked. Two perpendicular measurements of spread are taken and averaged in millimeters and converted into a Melt Test Value according to the following conversion table:

Melt Test Conversion Table

| mm | Melt Test Value | mm | Melt Test Value |
|---|---|---|---|
| 39.8 | 1 | 43.05 | 1.5 |
| 46.3 | 2 | 49.55 | 2.5 |
| 52.8 | 3 | 56.05 | 3.5 |
| 59.3 | 4 | 62.55 | 4.5 |
| 65.8 | 5 | 69.05 | 5.5 |
| 72.3 | 6 | 75.55 | 6.5 |
| 78.8 | 7 | 88.55 | 7.5 |

An acceptable Melt Test value would be a value equal to or greater than 3.5.

C. Determination of Crumble Test Value for a Cheese Composition

As used herein, the term “Crumble Test Value” means the value assigned to a cheese composition after applying the following test protocol on the cheese. Cut cheese into large cubes and then shred the cubed samples using a Hobart shredder. Take a handful of the shredded cheese and squeeze the shreds firmly into the shape of a ball with the palm side of hand. Then rub the cheese ball firmly with the other hand over a container and rate the appearance of the shreds. A perfect shred will maintain its shape under moderate stress and therefore have a Crumble Test Value of 1. A poor shred will crumble into small pieces under small stress and therefore have a Crumble Test Value of 5. Acceptable levels of crumbliness are 1-2.5.

D. Determination of Stickiness Test Value for a Cheese Composition

As used herein, the term “Stickiness Test Value” means the value assigned to a cheese composition after applying the following test protocol on the cheese. Cut cheese into large cubes and then shred the cubed samples using a Hobart shredder. Take a handful of the shredded cheese and squeeze the shreds firmly into the shape of a ball with the palm side of hand. Then bounce the cheese ball several times in hand over a container. A perfect shred will fall apart easily into its original shreds and therefore have a Stickiness Test Value of 1. A poor shred will stick to the other shreds and therefore have a Stickiness Test Value of 5. Acceptable levels of stickiness are 1-2.5.

E. Determination of Firmness Test Value for a Cheese Composition

As used herein, the term “Firmness Test Value” means the value assigned to a cheese composition after applying the following test protocol on the cheese. A Firmness Test Value can be obtained from a Haake vane rheometer having Model No. RV12. An acceptable Firmness Test Value includes a torque measurement in the range from 60 to 80% torque units. The rheometer spindle speed was set at 0.5 rotations per minute.

### EXAMPLES

Provided below are non-limiting, illustrative examples of aerated cheese according to the invention and of the method of making such cheese.

### Example 1

An aerated cheese according to the invention was prepared using the following ingredients to form the cheese mixture: soy oil (26.6 lbs), casein (15.2 lbs), wheat gluten (1.94 lbs), Novation 1600 starch (2.75 lbs), sodium aluminum phosphate (1.5 lbs), (18 lbs), mozzarella cheese powder (2.32 lbs), water (46.65 lbs), and various additives and fillers (totaling about 3.02 lbs), including salt, potassium sorbate, citric acid, titanium dioxide, sodium citrate and trisodium phosphate, potassium chloride, vitamin premix, and vitamin A palmitate, each of the additives being present in amounts of less than 1 lb.

The oil was added to a jacketed tank and heated to 110° F. until the fat was completely melted. The casein, gluten, salt, starch, potassium chloride, vitamin premix, vitamin A palmitate, citric acid, and potassium sorbate was then added to this vessel and mixed until uniform. The water (less a pre calculated amount that will be added by steam injection heating) and the sodium aluminum phosphate were then added to a direct injection twin screw cheese cooker (Model No. CDB1028-RDG from Custom Stainless Steel Equipment), mixed and heated to 175° F. using direct injection steam. The casein/oil mixture was then added to the water mixture in the cooker to form the molten cheese mixture by heating the mixture to 175° F. for a total of 4.5 minutes.

The molten cheese mixture was added to a traced tank and fed into a Mondo pilot aerator Model No. MD2 at a nominal rate of 0.8-1.2 kg/hr. The nominal mixer speed setting was set at 360 rpm and the mixer backpressure setting was 2 bar. The nitrogen (N₂) flow rate was adjusted to give the molten cheese mixture a density of 0.95-0.98. The resultant aerated cheese mixture was filled into containers and cooled for 48 hours. After cooling, the density of the solidified aerated cheese was measured and it was found to be 1.0, equivalent to 5.7% N₂ by volume.

### Comparative Example 1

A comparative example or control was prepared from the same cheese mixture and process steps as in Example 1, except the molten cheese mixture was not subjected to an aeration step. After the molten cheese mixture was mixed for the prescribed time, it was filled into containers and cooled for 48 hours.

After cooling, samples of the aerated cheese of Example 1 and of the non-aerated cheese of Comparative Example 1 were shredded in an Urschel Laboratories Inc Model No. “CC” Cheese shredder at 20 rpm using corrugated blade #2210. The cheese of Example 1 shredded similarly to the control, and generated a much lower level of fines (#6 and #70 screen), considered a desirable result. Below in Table 1 is presented the size distribution data for the shreds and fines obtained from shredding of the samples based upon percent of total weight of the sample (Wt. %).

TABLE 1
Example 1 Distribution Data

| SHRED/FINES SIZE | EX. 1 (Wt. %) | CONTROL (Wt. %) |
|---|---|---|
| ½″ | 74.4 | 71.1 |
| 7/16″ | 8.1 | 7.0 |
| ¼″ | 9.3 | 11.4 |
| #6 | 5.2 | 6.4 |
| #70 | 3.0 | 4.1 |

The aerated cheese of Example 1 and non-aerated cheese of Comparative Example 1 were analyzed for stretch, melt, stickiness, crumbliness, shred appearance, and texture and the results are presented in the following Table 2:

TABLE 2
Example 1 Comparative Test Results

| TEST TYPE | Example 1 | Comparative Example 1 |
|---|---|---|
| Stretch | 2.5 inches | 4.5 inches |
| Melt | 4.5 | 4.0 |
| (Schreiber scale) | | |
| Stickiness | 1.0 | 1.0 |
| (Scale of 1 to 5) | | |
| Crumbliness | 1.5 | 1.5 |
| (Scale 1-5) | | |
| Appearance | A little dry, melt was | Acceptable/Good |
| | acceptable | |
| Texture | 53% torque | 61% torque |
| (Haake Hardness) | | |

Shreds of the aerated cheese of Example 1 and non-aerated cheese of Comparative Example 1 were baked on a cheese pizza and evaluated for melt. The melt of the aerated cheese of Example 1 was considered acceptable via team judging when compared to the non-aerated control.

### Example 2

For Example 2, the same molten cheese mixture was prepared as in Example 1. The molten cheese mixture was added to a traced tank and fed into an Mondo pilot aerator Model No. MD2 at a nominal rate of 0.8-1.2 kg/hr. The nominal mixer speed setting was set at 400 rpm and the mixer backpressure setting was 2.5 bar. The N₂ flow was adjusted to give a molten product density of 0.90-0.92. Samples of the aerated cheese mixture were filled into containers and cooled for 48 hours. After cooling, the density of the solidified aerated cheese was measured and it was found to be 0.97, equivalent to 9.3% N₂ or void fraction.

After cooling, the cheese was shredded in an Urschel Laboratories Inc. Model No. “CC” Cheese shredder at 20 rpm using corrugated blade #2210. The cheese shredded similar to control, and generated a lower level of fines (#6 and #70 screen), considered a desirable result. Below in Table 3 is presented the size distribution data for the shreds and fines obtained from shredding of the samples.

TABLE 3
Example 2 Distribution Data

| SHRED/FINES SIZE | Ex. 2 (Wt. %) | CONTROL (Wt. %) |
|---|---|---|
| ½″ | 76.5 | 71.1 |
| 7/16″ | 7.2 | 7.0 |
| ¼″ | 7.0 | 11.4 |
| #6 | 4.8 | 6.4 |
| #70 | 4.5 | 4.1 |

The aerated cheese of Example 2 and the non-aerated cheese of Comparative Example 1 were analyzed for stretch, melt, stickiness, crumbliness, shred appearance, and texture and the results are presented in the following Table 4:

TABLE 4
Example 2 Comparative Test Results

| TEST TYPE | Example 2 | Comparative Example 1 |
|---|---|---|
| Stretch | 2.5 inches | 4.5 inches |
| Melt | 5.0 | 4.0 |
| (Schreiber scale) | | |
| Stickiness | 1.0 | 1.0 |
| (Scale of 1 to 5) | | |
| Crumbliness | 1.5 | 1.5 |
| (Scale 1-5) | | |
| Appearance | A little dry/Melt was | Acceptable/Good |
| | acceptable | |
| Texture | 55% torque | 61% torque |
| (Haake Hardness) | | |

Shreds of the aerated cheese of Example 2 and non-aerated cheese of Comparative Example 1 were baked on a cheese pizza and evaluated for melt. The melt of the aerated cheese of Example 2 was considered acceptable via team judging when compared to the non-aerated control.

### Example 3

For Example 3, an aerated cheese was prepared according to the invention using the following ingredients to form the cheese mixture: soy oil (22.0 lbs), casein (12.1 lbs), wheat gluten (0.97 lbs), Novation 1600 starch (2.25 lbs), cornstarch (6.99 lbs), sodium aluminum phosphate (1.3 lbs), mozzarella cheese powder (2.32 lbs), water (49.15 lbs), and various additives and fillers (totaling about 2.96 lbs), including salt, potassium sorbate, citric acid, titanium dioxide, sodium citrate and trisodium phosphate, potassium chloride, vitamin premix, and vitamin A palmitate, each of the additives being present in amounts of less than 1 lb.

A molten cheese mixture was prepared from these ingredients following the same process steps used in Example 1. Then the molten cheese mixture was added to a traced tank and fed into a Mondo pilot aerator Model No. MD2 at a nominal rate of 0.8-1.2 kg/hr. The nominal mixer speed setting was set at 400 rpm and the mixer backpressure setting was 2.0 bar. The N₂ flow rate was adjusted to give the molten cheese mixture a density of 0.94-0.96. The resultant aerated cheese mixture was filled into cups and cooled for 48 hours. After cooling, the density was measured and it was found to be 1.01, equivalent to 5.6% N₂ or void fraction.

### Examples 4-8

A molten cheese mixture was prepared as in Example 1, added to a traced tank and fed into an Mondo pilot aerator Model No. MD2 at a nominal rate of 0.8-1.2 kg/hr. The nominal mixer speed, backpressure, and N₂ gas input rates were manipulated in order to generate aerated cheese samples with different molten product densities. The samples were then cooled, and their final densities and gas (void fraction) percents were estimated. The setting and data obtained for the different parameters of Examples 4-8 are presented in Table 5.

TABLE 5
% N₂ and Density Data

| | | | | % N₂ in | | |
|---|---|---|---|---|---|---|
| | | | | Aerated | | |
| Example | Mix | Back | | Molten | % N₂ in Cooled | |
| No. | Speed | Pressure | | Composition | Aerated Cheese | Density |
| Ex. 4 | 360 | 3 | bar | 9.1 | 6.6 | 1.0 |
| Ex. 5 | 360 | 4 | bar | 21.1 | 12.0 | .942 |
| Ex. 6 | 500 | 4 | bar | 21.5 | 11.0 | .952 |
| Ex. 7 | 400 | 4 | bar | 29.3 | 15.1 | .908 |
| Ex. 8 | 400 | 5.5 | bar | 32.7 | n/a | n/a |

The data shows the effect of different operating conditions on % N₂ in the process and how different densities can be obtained.

All patents, patent documents, and publications cited herein are incorporated by reference as if individually incorporated. Unless otherwise indicated, all parts and percentages are by weight of the total composition. The foregoing detailed description has been given for clarity of understanding only. No unnecessary limitations are to be understood therefrom. The invention is not limited to the exact details shown and described. Further, it will be understood by those skilled in the art that various changes, adaptations and modifications may be made without departing from the spirit of the invention and the scope of the appended claims.

What is claimed:

1. A process for making an aerated cheese, comprising the steps of:
aerating a molten cheese mixture with a gas in a high shear, aeration device to form an aerated molten cheese mixture;
cooling the aerated molten cheese mixture to solidify the mixture and form the aerated cheese.

2. The process of claim 1, further comprising the step of:
shredding the aerated cheese.

3. The process of claim 1, wherein the aeration step results in the solidified aerated cheese having less than about 50% gas content by total volume.

4. The process of claim 1, wherein the aeration step results in the solidified aerated cheese having from about 1% to about 50% gas content by total volume.

5. The process of claim 1, wherein the aeration step results in the solidified aerated cheese having from about 1% to about 40% gas content by total volume.

6. The process of claim 1, wherein the aeration step results in a solidified aerated cheese having from about 1% to about 30% gas content by total volume.

7. The process of claim 1, wherein the aeration step results in a solidified aerated cheese having from about 5% to about 30% gas content by total volume.

8. The process of claim 1, wherein the aeration step results in a solidified aerated cheese having from about 5% to about 20% gas content by total volume.

9. The process of claim 1, wherein the aeration step is carried out with a pin-type aerator at a gas flow rate sufficient to provide the aerated cheese with a gas content of from about 5% to about 50% gas by total volume.

10. The process of claim 1, further comprising the steps of preparing the molten cheese mixture prior to the aeration step; and adding an oil portion to the mixture in the aeration device.

11. A cheese, comprising a solidified aerated molten cheese mixture.

12. The cheese of claim 11, wherein the cheese has a bulk density of about 0.7 grams/cc and about 1.10 grams/cc.

13. The cheese of claim 11, wherein the cheese does not flow at room temperature when placed on a surface with no external forces applied.

14. The cheese of claim 11, wherein the cheese softens at baking temperatures.

15. The cheese of claim 11, wherein the cheese is in the form of cheese shreds and the cheese shreds have a length and a plurality of cross-sectional dimensions and a plurality of gas bubbles that are of a size not larger than ½ of the narrowest cross-sectional dimension.

16. The cheese of claims 11, wherein the cheese has a gas content of no more than 50% by total volume.

17. The cheese of claims 11, wherein the cheese has a gas content from about 1% to about 50% by total volume.

18. The cheese of claims 11, wherein the cheese has a gas content from about 1% to about 40% by total volume.

19. The cheese of claims 11, wherein the cheese has a gas content from about 1% to about 30% or about 1% to about 20% or about 5% to about 20% by total volume.

20. An aerated cheese comprising a solidified aerated molten cheese mixture, wherein the cheese has a gas content of about 20% to about 1% by total volume of the cheese, a bulk density of about 0.7 grams/cc to about 1.10 grams/cc and an average void size in the range of about 1500 microns to about 0.1 microns.
